(19) United States
(12) Patent Application Publication
(10) Pub. No.: US 2003/0117722 A1
(43) Pub. Date: Jun. 26, 2003

(54) Structure of digital imaging lens

(75) Inventor: Tien-Ching Chen, Taichung (TW)

Correspondence Address: BROWDY AND NEIMARK, P.L.L.C., 624 NINTH STREET, NW, SUITE 300, WASHINGTON, DC, 20001-5303, US

(73) Assignee: GENIUS ELECTRONIC OPTICAL (XIAMEN) CO., LTD., Xiamen (CN)

(21) Appl. No.: 10/097,726

(22) Filed: Mar. 15, 2002

(30) Foreign Application Priority Data
Dec. 25, 2001 (CN) 01273098.X

(51) Int. Cl. G02B 9/60

(52) U.S. Cl. 359/770

(57) ABSTRACT

A digital imaging lens is constructed to include a fixed iris, and an optical unit, the optical unit including five lenses arranged in proper order behind the fixed iris, the first lens being a biconvex lens disposed at the front side behind the fixed iris, the fifth lens being a biconvex lens disposed at the rear side, the second lens being a biconcave lens spaced between the first lens and the third lens, the third lens being a positive meniscus lens having its convex surface facing the image side, the fourth lens being a negative meniscus lens having its convex surface facing the object side, the fifth lens being a biconvex lens adhered to the fourth lens.

### BACKGROUND OF THE INVENTION

1. Field of the Invention

The present invention relates to a camera lens for a camera of fixed focal length and, more specifically, to a digital imaging lens for use in a digital still camera or PC camera.

2. Description of the Related Art

Following fast development of personal computer technology, a variety of digital still cameras have been disclosed for use with personal computers, and intensively used in families. A regular digital still camera uses a solid state image pickup device (for example, charge-coupled device or complementary metal-oxide semiconductor) to pick up the image of an object, enabling the image thus obtained to be transferred through a data line to a personal computer, which uses a software program to convert the image into a JPEG, GIF (graphics interchange format), or TIFF (tagged image file format) file. In order to meet the tendency of the designing of digital still cameras toward microminiaturization, matching solid-state image pickup devices and related lenses are required to be as small as possible, i.e., the dimensions of the solid-state image pickup devices and the length of the lenses must be minimized. When minimizing the dimensions of a solid-state image pickup device, the overall length of the camera lens must be relatively shortened. According to conventional designs, a camera lens is comprised of a number of lenses axially aligned in a line, and an iris arranged in between two of the lenses. Because the iris is spaced between two lenses, the total distance of the camera lens cannot be shorted to the desired level. Furthermore, because a big number of lenses are used, the cost of the camera lens is high.

### SUMMARY OF THE INVENTION

The present invention has been accomplished to provide a digital imaging lens, which eliminates the aforesaid drawbacks. It is one object of the present invention to provide a digital imaging lens, which is suitable for use in a digital still camera or PC camera. It is another object of the present invention to provide a digital imaging lens, which requires less assembly space. It is still another object of the present invention to provide a digital imaging lens, which is inexpensive to manufacture. To achieve these and other objects of the present invention, the digital imaging lens is comprised of a fixed iris, and an optical unit disposed in axial alignment with the fixed iris. The optical unit comprises a first lens, a second lens, a third lens, a fourth lens, and a fifth lens arranged in proper order from the objective side toward the image pickup device side behind the fixed iris. The first lens is a biconvex lens disposed at behind the fixed iris. The fifth lens is a biconvex lens disposed at the rear side. The second lens is a biconcave lens spaced between the first lens and the third lens. The third lens is a positive meniscus lens having its convex surface facing the image side. The fourth lens is a negative meniscus lens having its convex surface facing the object side. The fifth lens is a biconvex lens. The fourth lens and the fifth lens are cemented together to form a positive compound lens.

According to the aforesaid arrangement, the digital imaging lens has a simple structure and compact size. The arrangement of the digital imaging lens greatly reduces the optical distortion, improving the image quality. When used with a CMOS (complementary metal-oxide semiconductor) type solid-state image pickup device, the camera cost can be greatly reduced. This design of digital imaging lens is suitable for use in small digital imaging products such as digital still cameras, and PC cameras.

### BRIEF DESCRIPTION OF THE DRAWINGS

FIG. 1 is a schematic drawing showing the arrangement of a digital imaging lens constructed according to the present invention.

FIG. 2 is a schematic drawing showing the digital imaging lens installed in a digital still camera according to the present invention.

### DETAILED DESCRIPTION OF THE PREFERRED EMBODIMENT

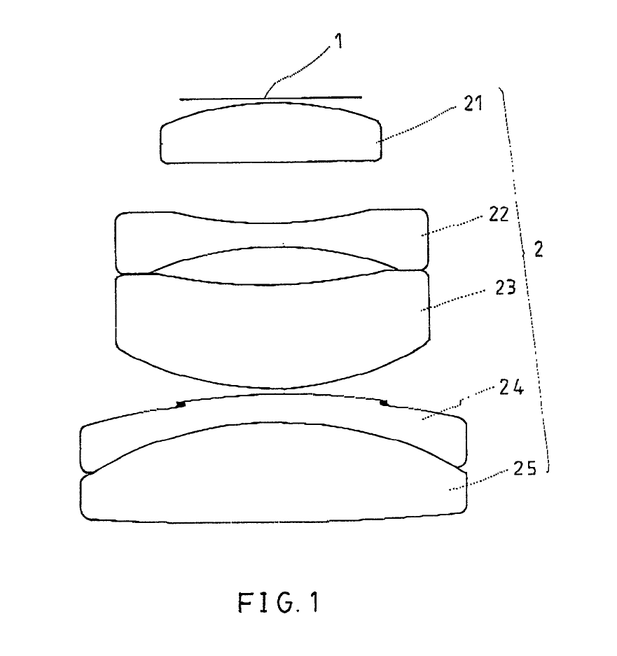

Referring to FIG. 1, a digital imaging lens in accordance with the present invention is to be used in a digital still camera or the like, comprised of a fixed iris 1, and an optical unit 2 arranged in axial alignment with the fixed iris 1. The optical unit 2 is comprised of a first lens 21, a second lens 22, a third lens 23, a fourth lens 24, and a fifth lens 25 arranged one behind another in proper order in axial alignment with the fixed iris 1. The first lens 21 is a biconvex lens disposed at the front side of the optical unit 2. The second lens 22 is a biconcave lens. The third lens 23 is a positive meniscus lens having its convex surface facing the image side. The fourth lens 24 is a negative meniscus lens having its convex surface facing the objective side. The fifth lens 25 is a biconvex lens. The fourth lens 24 and the fifth lens 25 are cemented together to form a compound lens. The fixed iris 1 is disposed in front of the first lens 21.

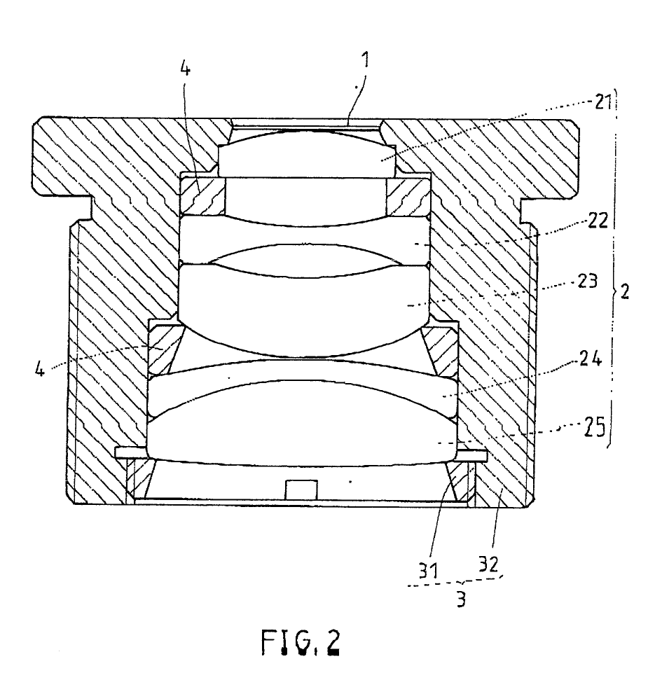

Referring to FIG. 2, the aforesaid digital imaging lens is installed in the lens holder 3 of a digital still camera (not shown). The lens holder 3 is composed of a cover 31 with a barrel 32 capped in the cover 31, and space 4 mounted inside the barrel 32 to hold the optical unit 2 in position.

What the invention claimed is:

1. A digital imaging lens comprising a fixed iris, and an optical unit disposed in axial alignment with said fixed iris, said optical unit comprising, a first lens, a second lens, a third lens, a fourth lens, and a fifth lens arranged in proper order in a line behind said fixed iris, said first lens being a biconvex lens disposed at a front side of said optical unit behind said fixed iris, said fifth lens being a biconvex lens disposed at a rear side of said optical unit, said second lens being a biconcave lens spaced between said first lens and said third lens, said third lens being a positive meniscus lens having its convex surface facing the image side, said fourth lens being a negative meniscus lens having its convex side facing the object side, said fifth lens being a biconvex lens. The said fourth lens and the said fifth lens are cemented together to form a positive compound lens.
